(19) United States
(12) Patent Application Publication
(10) Pub. No.: US 2012/0282444 A1
(43) Pub. Date: Nov. 8, 2012

(54) LAMINATING ADHESIVE HAVING SILANE CROSS-LINKING

(75) Inventors: Lars Zander, Neuoetting (DE); Pavel Gentschev, Bad Goisern (AT); Hans-Georg Kinzelmann, Pulheim (DE); Svenja Struempf, Solingen (DE); Nicole Ditges, Solingen (DE); Johann Klein, Duesseldorf (DE)

(73) Assignee: Henkel AG & Co. KGaA, Duesseldorf (DE)

(21) Appl. No.: 13/460,068

(22) Filed: Apr. 30, 2012

Related U.S. Application Data
(63) Continuation of application No. PCT/EP2010/063960, filed on Sep. 22, 2010.

(30) Foreign Application Priority Data
Oct. 30, 2009 (DE) 102009046190.6

(51) Int. Cl. C09J 183/00; B32B 15/082; B32B 27/10; B32B 27/08; B32B 7/12; B32B 33/00

(52) U.S. Cl. 428/195.1; 524/588; 524/492; 428/355 AC; 428/344; 428/354

(57) ABSTRACT

The invention relates to a one-component, moisture-curing adhesive containing at least one polyoxyalkylene and/or poly(methyl)acrylate prepolymer having at least one hydrolyzable silane group, at least one filler, and auxiliary materials and additives, wherein the prepolymer has a molecular weight of 4,000 to 40,000 g/mol and the adhesive has a viscosity of 200 to 10,000 mPas.

The invention relates to one-component adhesives that are based on silane-functionalized prepolymers and can be applied in flowable fashion. They are intended to be transparent, and to be capable of curing without bubbles. The invention further relates to multi-layer films that comprise, as a laminating adhesive layer, a crosslinked adhesive based on said silane-functionalized prepolymers.

Moisture-curing elastic adhesives and sealants are used industrially in many sectors. It is desirable in this context that these adhesive bonds be capable of being carried out on different substrates without an obligatory need to carry out a pretreatment using a primer or using physical methods such as corona treatment or plasma treatment. Adhesives and sealants of this kind based on reactive polyurethane prepolymers are known. As a result of manufacture, they often still contain small proportions of monomeric isocyanates. This is, however, objectionable in terms of health. In addition, it often becomes apparent that PU-based adhesives do not meet requirements for color stability upon exposure to light. Furthermore, bubbles form in the adhesive layer at high humidity because of the isocyanate groups.

Laminating adhesives are used for adhesive bonding of flexible substrates, for example for films made of plastic or metal, papers, or fiber materials. They are intended to result in good adhesion to the substrate; it is furthermore necessary for the adhesives to be capable of being applied in thin layers. Rapid adhesive bonding is to be ensured, thus enabling further processing as directly as possible without long waiting times. The cohesion of the adhesives is thus intended to be high even before crosslinking.

Adhesive compositions that comprise a polymer backbone based on polymers of different compositions, which additionally contain silane groups crosslinkable with moisture, are known. U.S. Pat. No. 4,222,925, for example, describes a sealing compound that contains a mixture of a polyurethane prepolymer that contains alkoxysilane groups on the chain, as well as small proportions of y-aminopropyltrimethoxysilane. Utilization for adhesive bonding of flexible films is not described.

DE 10237271 describes polymer compounds that contain alkoxysilane-terminated polymers. Acids, bases, organometallic compounds, or organic amino compounds can also be contained as catalysts. Plasticizers or fillers can furthermore be contained in the polymer compound. Polyolefins, polyacrylates, polyesters, polyethers, or polyurethanes, among others, are listed as polymers, without being further described.

EP 1303569 describes polymers that carry at least two SiOR groups on a polymer backbone. Polyolefins, polyacrylates, polyesters, polyethers, polyurethanes, and further types are listed as a polymer structure, with no description of them as to their parameters. The binding agents can be used in adhesives, paints, or foam precursors. A more detailed description of the adhesives is not given.

DE 10 2006 059473 is also known. This describes one-component adhesive and sealant compounds that are made up of a silane-functional polyoxyalkylene prepolymer and a silane-functional polyolefin. A variety of additives are added to this compound, for example nonpolar plasticizers as well as the known tackifying resins.

Laminating adhesives according to the known existing art have the disadvantage that their mechanical properties are often not sufficient. A rapid buildup of the adhesive bond is not present. In addition, they are intended to have a low viscosity so they can be applied with a thin layer thickness. Good elasticity often is not present, in particular when a high crosslinking density of the sealant is obtained. When such adhesives are manufactured on a polyurethane basis, rapid crosslinking is possible but bubbles occur to a greater extent in the adhesive film because of the fast-reacting NCO groups that are required. Such adhesives are also often not clear and colorless.

An object of the present invention is therefore to make available an adhesive, easy to apply at elevated temperature if applicable, that produces flawless adhesive bonding of flexible films. No bubbles are intended to occur in the adhesive layer upon adhesive bonding; said layer is further intended to yield, permanently, no discoloration when exposed to light and atmospheric influences. The adhesive layer is intended to yield a rapid and cohesive connection to the substrates. A further object of the present invention is that these adhesives can be applied without a primer onto the various substrates, and yield good adhesion to the substrates.

The object is achieved by making available a one-component moisture-curing laminating adhesive containing at least one polyoxyalkylene and/or poly(meth)acrylate prepolymer having at least one hydrolyzable silane group, at least one filler, auxiliary substances and/or additives, the prepolymer having a molecular weight of 4000 to 40,000 g/mol and the adhesive having a viscosity of 2000 to 100,000 mPas.

The one-component adhesive according to the present invention can contain a polyoxyalkylene prepolymer having at least one hydrolyzable silane group. These prepolymers can in principle be linear or branched, and can also comprise multiple silane groups. It is preferred, however, if said silane groups are located terminally with respect to the polymer chain. Silane-containing prepolymers of this kind, based on polyethers, can be manufactured in various ways.

The polymer backbone is constructed on the basis of polyoxyalkylene chains. The chains can carry, at the chain ends, functional groups that are then converted by further reaction into silane groups. Polyether polyols, for example, are suitable as starting polymers.

Polyoxyalkylene polyols, for example, are used as polyols for the prepolymers according to the present invention having silane groups. These can be the known polyether polyols based on polyethylene oxide, polypropylene oxide, or poly-THF; mixtures with different modules can also be used. Di- or trifunctional polyether polyols based on polypropylene glycol are particularly suitable. Such polyols are known to one skilled in the art. According to the present invention, mixtures of several polyether polyols having different molecular weights can likewise be used. Such polyols can be functionalized with silane groups, individually or as a mixture. For example, hydroxy-functional polyethers are reacted with unsaturated chlorine compounds, e.g. allyl chloride, in an ether synthesis to yield polyethers having terminal olefinic double bonds, which in turn are reacted with hydrosilane compounds that comprise hydrolyzable groups, for example, HSi(OCH₃)₃, in a hydrosilylation reaction under the catalytic influence of, for example, transition metal compounds of the eighth group, to yield silane-terminated polyethers.

In another method, polyethers containing olefinically unsaturated groups are reacted with a mercaptosilane such as, for example, 3-mercaptopropyltrialkoxysilane.

In a further method, firstly OH-containing polyethers are reacted with an excess of di- or polyisocyanates, which are then reacted with amino-functional, hydroxy-functional, or mercapto-functional silanes to yield silane-terminated prepolymers. The known aliphatic or aromatic diisocyanates are suitable as isocyanates, for example 1,6-hexamethylene diisocyanate (HDI), 1-isocyanato-3,3,5-trimethyl-5-isocyanatomethylcyclohexane (IPDI), xylylene diisocyanate (XDI), tetramethylxylylene diisocyanate (TMXDI), 2,4- or 2,6-toluoylene diisocyanate (TDI), 2,4′-diphenylmethane diisocyanate, 2,2′-diphenylmethane diisocyanate, or 4,4′-diphenylmethane diisocyanate (MDI), as well as isomer mixtures thereof. The quantity is selected so that an NCO-terminated prepolymer is obtained. These reaction products are then further reacted with silanes that comprise hydrolyzable groups as well as a group that reacts with NCO groups.

A further possibility provides for reacting hydroxy-functional polyethers with isocyanato-functional silanes. One skilled in the art knows how to select the silanes, methods and reaction conditions.

If hydroxy-functional polyethers are used by reaction to silane-terminated prepolymers, a preferred embodiment uses polyether polyols that are manufactured by DMC catalysis. These are notable for a narrow polydispersity; in addition, there is only a low proportion of non-difunctional compounds.

Another embodiment of the laminating adhesive according to the present invention uses a prepolymer based on polyacrylates, which is likewise intended to comprise at least one hydrolyzable silane group on the polymer chain. “Polyacrylate polymers” are also to be understood, for purposes of this invention, as methacrylate polymers and copolymers. It is likewise possible to use mixed block copolymers of polyethers and polyacrylates.

The poly(meth)acrylates suitable according to the present invention are polymerization products of one or more alkyl (meth)acrylate esters having 1 to 12 carbon atoms in the alcohol residue. Small proportions of (meth)acrylic acid or other copolymerizable monomers, for example styrene, vinyl esters, acrylamides, can optionally also be contained. C₁ to C₈ (meth)acrylate esters are particularly suitable. Such polymers are known to one skilled in the art and can be manufactured in a variety of ways. They are also commercially obtainable in various chemical compositions.

Acrylate copolymers suitable according to the present invention are intended to comprise at least two, preferably between 2 and 5, hydrolyzable silane groups. These silane groups are the silane groups mentioned above, having hydrolyzable residues. In this case as well, di- or trialkoxysilane groups having C₁ to O₄ alkoxy groups are particularly preferred.

The silanes can be bound to the basic polymer structure using a variety of manufacturing approaches. For example, it is possible to polymerize in silanes that contain an unsaturated residue and hydrolyzable groups. In this case the silane groups are then distributed statistically over the polymer chain.

Another procedure works in such a way that acrylate polymers having unsaturated groups are produced, the unsaturated double bonds then be reacted with silanes. In this case it is also possible to obtain such unsaturated groups, and thus the silane groups, terminally on the acrylate copolymer.

A further procedure involves manufacturing acrylate polymers containing OH groups. These polymers can then be reacted directly with isocyanatosilanes; or they are reacted with an excess of diisocyanates, and the unreacted isocyanate groups are then reacted with silanes that additionally contain a nucleophilic group.

A further embodiment of the invention uses acrylate block copolymers that comprise hydrolyzable silane groups. The latter are located preferably in the externally sited acrylate blocks. Such polymers are described, for example, in DE 10 2008 002 016. Poly (meth)acrylate copolymers having one or more reactive silane groups are also commercially obtainable.

In a preferred embodiment of the composition according to the present invention, the molecular weight (number average molecular weight M_{N}, determinable by GPC) of the (meth)acrylate polymers or polyether polymers is equal to between 2000 and 75,000 g/mol. Further particularly preferred molecular weight ranges are 4000 to 50,000 g/mol, very particularly preferably up to 40,000 g/mol. These molecular weights are particularly advantageous because they enable good processability. It is very particularly preferred to use polymers that have a polydispersity D (measured as M_{W}/M_{N}) of less than 3, preferably less than 2, in particular less than 1.5.

It is also possible to use polymers having a higher molecular weight. If the viscosity of the composition according to the present invention is higher than desired, for example because of a high molecular weight or strong internal bonding forces, the processing viscosity can be adjusted by adding reactive diluents or plasticizers, thereby producing a composition that exhibits the desired properties.

It is possible to use the silane-containing polymers based on polyethers or poly (meth)acrylates individually, or also in a mixture with a different composition or molecular weight. Attention must also be paid in this context to the compatibility of the polymers. Compatibility can be influenced by way of the polymers themselves; for example, acrylates having proportions of longer-chain alkyl acrylates as a monomer constituent have more pronounced nonpolar properties. Silane-reactive polyethers are, however, particularly preferred as binding agents.

The reactive silane group is intended to contain hydrolyzable residues. Examples of such residues are —Cl, —OH, —O—C(═O)R¹, —OR¹, where R¹ denotes a hydrocarbon residue having 1 to 20 carbon atoms. According to a preferred embodiment, they are intended to correspond to the general formula (I)

—SiR³_{b}(OR)ₐ (I)

where R=C(O)R¹ or R², and R¹ and R²=C₁ to C₁₀ alkyl,
R³=C₁ to C₆ alkyl, and
a=1, 2, 3 and b=0, 1, 2.

C₁ to C₄ alcohol residues or C₂ and C₃ carboxylic acid residues are particularly preferred as R. These residues can be contained on the silicon atom either alone or also mixed. The number of these hydrolyzable residues is intended to equal one to three, in particular two or three. Tri- or dialkoxysilane groups having methoxy, ethoxy, propoxy, or butoxy groups are, for example, suitable. In addition, 0, 1, or 2 alkyl groups can also be contained on the silicon atom, in particular methyl, ethyl, propyl, or butyl groups.

The reactive silane group is covalently bound onto the polymer chain. It can be present, for example, in a manner bound via an alkylene group, but it is also possible for a bond via heteroatoms to be present. This can occur, for example, via atoms of nitrogen, sulfur, or oxygen. It is likewise possible for other heteroatoms, which can influence the reactivity of the silane group, to be present in the vicinity of the silane groups.

As indicated above, the silane group can be introduced by a variety of methods upon manufacture of the polyether prepolymers. In a preferred embodiment, OH-functional polyethers are reacted with an excess of diisocyanates to yield terminally NCO-functionalized prepolymers that are then reacted with silane compounds known per se, said compounds containing at least one silane group and a further nucleophilic functional group that is reactive with an isocyanate group. It is also possible for two or three silane groups to be contained in this compound. The molecular weight of this reactive compound is to be less than 1000 g/mol, in particular less than 500 g/mol.

The nucleophilic group can be, for example, terminal with respect to the alkyl group, or it is in the α-position with respect to the silane. Examples of silanes containing nucleophilic substituents are 3-mercaptopropyltrimethoxysilane, 3-aminopropyltrimethoxysilane, N-(2-aminoethyl)-3-aminopropyltrimethoxysilane, or N-(2-aminoethyl)-3-aminopropylmethyldiethoxysilane, corresponding ethoxy- or propoxysilanes, and the analogous alkyldialkoxysilanes, for example methyl-, ethyl-, butyldialkoxysilanes. Examples of silanes containing NCO groups are trimethoxysilylpropylisocyanate, trimethoxysilylpentylisocyanate, trimethoxysilylbutylisocyanate, and corresponding ethoxy- or propoxysilanes, or analogous methyldialkoxy-substituted silanes. Silanes having mixed alkoxy groups are also suitable.

Another embodiment uses silane compounds having hydrolyzable groups that additionally contain an NCO group. Examples thereof are isocyanatoalkyltrialkoxysilanes or isocyanatoalkyldialkoxysilanes; in particular, methoxy, ethoxy, or propoxy groups can be contained.

The number of silane groups must be equal to at least one per polymer chain, but as many as ten silane groups can also be contained. Preferably, an average of approx. 1.5 to approx. 3 silane groups are to be contained. In a particular embodiment, on average two silane groups are contained terminally with respect to the polyether chain.

The silane-reactive polyoxyalkylene prepolymers or poly(meth)acrylates are usually highly viscous at room temperature (25° C.). The viscosity can be equal to from 1000 up to 100,000 mPas (measured per Brookfield, EN ISO 2555). Polyethers suitable according to the present invention that comprise a corresponding number of silane groups are commercially obtainable with a variety of molecular weights or chain structures.

The one-component laminating adhesive according to the present invention must additionally contain at least one finely distributed pigment or filler. Such fillers are understood as finely distributed fillers or pigments that have a high surface area. So-called nano-fillers are particularly suitable. Examples of such fillers are oxides or oxide/hydroxide compounds based on Si, Ti, Zr, Ba, Ca, Mg, Fe, or the like. These fillers/pigments are intended in particular to be colorless. It is advantageous according to the present invention if these pigments are transparent when dispersed in the binding agents. This can be influenced by way of the particle size selected. The surface area is to be measured, for example, as the BET surface area (per DIN 66131). Finely distributed pigments or fillers suitable according to the present invention have a surface area of between 5 and 100 m², in particular between 10 and 50 m², per gram. The quantity of fillers and/or pigments is intended to be between 1 and 30 wt %, in particular from 2 to 15 wt %.

A particular embodiment of the invention works with silicic acid. Either a silicic acid of this kind can be used directly, or the fillers are surface-treated. The silicic acids are highly dispersed. The particle diameter is selected so that transparent coatings result. The cohesion of the adhesive layer is intensified by the quantity of fillers, in particular of silicic acids. Such fillers are known to one skilled in the art, and are commercially obtainable.

The adhesive according to the present invention can furthermore contain auxiliary substances and additives. These can be, for example, plasticizers, stabilizers, antioxidants, fillers, diluents resp. reactive diluents, drying agents, adhesion promoters, and UV stabilizers, catalysts, pigments.

Suitable liquid plasticizers are, for example, white oils, naphthenic mineral oils, polypropylene, polybutylene, polyisoprene oligomers, hydrogenated polyisoprene and/or polybutadiene oligomers, benzoate esters, phthalates, adipates, vegetable or animal oils and derivatives thereof, paraffinic hydrocarbon oils, polypropylene glycol and polybutylene glycol, liquid polyester, glycerol esters, or fatty acids having by preference 8 to 36 carbon atoms.

“Stabilizers” for purposes of this invention are to be understood as antioxidants, UV stabilizers, or hydrolysis stabilizers. Examples thereof are the commercially usual sterically hindered phenols and/or thioethers and/or substituted benzotriazoles and/or amines of the HALS (hindered amine light stabilizer) type. It is preferred in the context of the present invention if a UV stabilizer that carries a silyl group, and that reacts into the final product upon crosslinking resp. curing, is used. Benzotriazoles, benzophenones, benzoates, acrylates, sterically hindered phenols, phosphorus, and/or sulfur can also be added. The preparation according to the present invention can contain up to approximately 3 wt %, by preference approximately 2 wt %, stabilizers.

All known compounds that can catalyze the hydrolytic cleavage of the hydrolyzable groups of the silane groupings, and the subsequent condensation of the Si—OH group into siloxane groupings (crosslinking reaction resp. adhesion promotion function), can be used as catalysts. Examples thereof are titanates such as tetrabutyl titanate or titanium tetraacetylacetonate; bismuth compounds such as bismuth tris-2-ethylhexanoate; tin carboxylates such as dibutyltin dilaurate (DBTL), dibutyltin diacetate, or dibutyltin diethylhexanoate; tin oxides such as dibutyltin oxide and dioctyltin oxide; organoaluminum compounds such as aluminum trisacetylacetonate; chelate compounds such as zirconium tetraacetylacetonate; amine compounds or salts thereof with carboxylic acids, such as octylamine, cyclohexylamine, benzylamine, dibutylamine, monoethanolamine, triethanolamine, diethylenetriamine, triethylenetetramine, triethylenediamine, guanidine, morpholine, N-methylmorpholine, and 1,8-diazabicyclo-(5,4,0)-undecene-7 (DBU); silane adhesion promoters having amino groups. One embodiment works in a manner free of metal catalysts; another uses catalysts that contain no heavy metals such as Sn or Pb. Mixtures of several catalysts are preferred, in a quantity from 0.01 to approximately 5 wt % based on the total weight, in particular from 0.1 to 4 wt %, particularly 0.5 to 3 wt % catalyst.

The adhesive according to the present invention can also contain adhesion promoters. These can be reactive substances that can participate in a reaction with the substrate surface, or substances that increase tackiness on the substrate.

Organofunctional silanes such as hydroxy-functional, (meth)acryloxy-functional, mercapto-functional, amino-functional, or epoxy-functional silanes are preferably used as adhesion promoters. These can optionally be incorporated into the polymer network. Examples of mercapto-functional silanes are 3-mercaptopropyltrimethoxylsilane or 3-mercaptopropyltrimethoxysilane. Examples of (meth)acryloxy-functional silanes are 3-acryloxypropyltrialkoxysilane or 3-methacryloxypropyltrialkoxysilane. Examples of epoxy-functional silanes are 3-glycidyloxymethyltrimethoxysilane, 3-glycidylmethyltriethoxysilane, or 2-glycidoxyethyltrimethoxysilane. Examples of aminofunctional silanes are 3-aminopropylmethyldimethoxysilane, N-(2-aminoethyl)-3-aminopropyltrimethoxysilane (DAMO), N,N-di(2-aminoethyl)-3-aminopropyltrimethoxysilane, N-(2-aminoethyl)-N′-(2-aminoethyl)-3-aminopropyltrimethoxysilane, bis-(triethoxysilylpropyl)amine, N-(n-butyl)-3-aminopropyltriethoxysilane, or mixtures thereof. Correspondingly suitable compounds are likewise the analogous ethoxy or propoxy derivatives, as well as alkyldialkoxy derivatives or the derivatives replaced with another alkyl group instead of the respective propyl group. Condensates of the aminosilanes recited previously can also be used as adhesion promoter components. Such adhesion promoters are known in the literature.

The aforementioned adhesion promoters are used in the binding agent compositions by preference in quantities between 0.1 and 10 wt %, by preference between 0.5 and 5, particularly preferably more than 1 wt %.

Also suitable as adhesion promoters are tackifying resins, such as modified or unmodified resin acids resp. esters, polyamines, polyaminoamides, anhydrides, and anhydride-containing copolymers or polyepoxy resins in small quantities. Typical tackifying resins (tackifiers) such as resin acid derivatives are used in concentrations between 5 and 20 wt %; typical adhesion promoters such as polyamines, polyaminoamides, or resorcinol derivatives are used in the range between 0 and 10 wt %.

Hydrolyzable silane compounds are suitable in particular as drying agents. Examples thereof are carbamatopropyltrimethoxysilane, alkyltrimethoxysilane, alkyltriethoxysilane, vinyltrimethoxysilane, phenyltrimethoxysilane, tetraethoxysilane, vinyltriethoxysilane, vinyltriacetoxysilane, or isooctyltrimethoxysilane. They furthermore cause the adhesive to exhibit a higher crosslinking density. This results, after crosslinking, in products having a higher modulus or greater hardness. These properties can therefore be influenced in controlled fashion by way of the quantity used.

A preferred embodiment of the adhesive according to the present invention can contain:

30 to 95 wt %, preferably 60 to 90 wt %, of one or more polyoxyalkylene polymers and/or poly(meth)acrylate polymers having at least two silane groups, in particular 2 to 4 silane groups,

0.1 to 10 wt %, in particular 0.5 to 5 wt %, of at least one additional adhesion promoter,

1 to 30 wt %, preferably 2 to 15 wt % fillers, and

0.01 to 25 wt % auxiliary substances and additives, in particular catalysts, adhesion promoters; stabilizers, and/or plasticizers.

The sum of the constituents is to be equal to 100 wt %.

The adhesive according to the present invention can be manufactured by mixing the constituents. It is advantageous in this context to perform the mixing at elevated temperature so that a more readily flowable composition is mixed. It is likewise possible to manufacture the composition continuously in an extruder. The sequence of addition and mixing is dependent on the viscosity, consistency, and quantity of the individual constituents. The solids are intended to be homogeneously dispersed or dissolved in the liquid constituents. Good mixing is to be ensured, so that no separation of individual constituents can occur. It may be useful to dry individual constituents in order to ensure good shelf stability. The mode of manufacture is known in principle; one skilled in the art can easily determine it as a function of the selection of raw materials.

The one-component moisture-curing laminating adhesive according to the present invention is intended, at room temperature, to be flowable but to exhibit a high viscosity. It is useful according to the present invention if the adhesive has, at a temperature between 20 and 30° C., a viscosity of 2000 to 100,000 mPas. The viscosity is influenced by the selection of the prepolymers and by the quantity of fillers.

It is possible to heat the adhesive according to the present invention to an elevated temperature, for example to 30 to 60° C. The viscosity is thereby lowered, and easier processing (such as pumping or application) is possible. Because the adhesive according to the present invention is applied in a thin layer, the latter is rapidly cooled to a lower temperature after application and accordingly once again exhibits a high viscosity.

It is also possible to reduce the viscosity for application by adding small proportions of solvents, but the embodiment in which the adhesive according to the present invention is free of organic or inorganic solvents is advantageous according to the present invention. This utilization mode can be applied and adhesively bonded at high speed, since no flash-off of solvents from the applied adhesive layer is necessary.

The methods for manufacturing the adhesively bonded laminates are known in principle. It is necessary in this context to apply the one-component adhesive according to the present invention uniformly in a thin layer. Application can occur in principle by printing, spraying, blading, or rolling, although it is useful to select a roller application method if a higher viscosity for the adhesive is desired.

According to a usual embodiment, the adhesive is applied at elevated temperature. This allows application of a thin layer, for example between 2 and 20 μm. In the case of a solvent-free form, a second film-shaped substrate is bonded against the first substrate immediately after application. This can optionally be carried by means of elevated pressure. It is furthermore also possible to adhesively bond multiple layers in immediate succession using an adhesive according to the present invention. When solvent-containing adhesives are used, provision must be made for evaporation of the volatile components prior to adhesive bonding.

Thanks to the elevated viscosity and high tack, a good connection is produced between the substrates directly after production. The substrates remain adhesively bonded against one another in slip-proof fashion even during further processing steps, so that further processing can be performed immediately. Final crosslinking occurs with the moisture present on the substrates resp. in the environment.

Preferred embodiments are those of the form described above having the further features such as, for example:
one-component adhesives such that trialkoxysilane groups or alkyldialkoxysilane groups, in particular of C₁, C₂, C₃, to C₄ alkanols, are contained as hydrolyzable silane groups;
one-component adhesive such that catalysts, adhesion promoters, pigments, and/or stabilizers are contained as an auxiliary substance and additives;
one-component adhesives such that the adhesive is solvent-free and/or is free of heavy metal catalysts;
one-component adhesives such that the adhesive contains no NCO groups;
one-component adhesives of a composition such that 60 to 90 wt % of one or more prepolymers having at least two silane groups, 0.5 to 5 wt % of a silane-based adhesion promoter, 2 to 15 wt % fillers, and 0.01 to 25 wt % catalysts, adhesion promoters, and/or stabilizers are contained, the sum being intended to equal 100%,
a use of the one-component adhesives according to the present invention as laminating one-component adhesives that can be applied at high temperature.

A further subject of the invention is the use of an adhesive according to the present invention for the adhesive bonding of flexible substrates. The known films or web-shaped substrates can be used in this context. These can be made, for example, of metal foils, paper webs, plastic films. The latter can be imprinted or coated. These films can be laminated onto one another; it is also possible to apply them onto other substrates such as paperboard, cardboard, or similar substrates that are flexible but in principle dimensionally stable.

It is possible in this context for the surface of the substrates to be processed before adhesive bonding. It is usual to clean off adhering loose constituents. It is additionally possible, optionally, to activate the surfaces, or primers are applied onto a substrate.

In particular, however, utilization of primers is not necessary in the context of the use of the adhesives according to the present invention.

The substrates can also be coated or imprinted on the surface. The imprinted surface can be coated with the adhesive, or it is adhesively bonded as a second substrate surface against a coated surface. It is advantageous according to the present invention if the adhesive is colorless and transparent. A possible printed image is not to be negatively affected.

The film substrates produced according to the present invention can be used for various types of packages. These can be food packages, packages for medical purposes, or other film packages. It is also possible to sterilize the substrates adhesively bonded according to the present invention after the manufacture of packaging objects. This can occur by irradiation or by the action of temperature and moisture on the substrates.

The adhesive according to the present invention can be applied in thin layers. It enables a rapid application method, good adhesion and cohesion and after adhesive bonding being obtained. Transparent adhesive layers, which also result in colorless layers after curing, are obtained by way of the selection of the adhesive according to the present invention. By avoiding isocyanates or other reactive groups that react quickly with water, it is also possible to ensure that gas bubbles do not form as defects in the adhesively bonded substrates.

### Silane-Modified Prepolymer 1

328 g (28 mmol) polypropylene glycol 12000 (OH number=9.6) is dried in a 500 ml reactor at 80° C. under vacuum. Under a nitrogen atmosphere at 80° C., 0.07 g bismuth(III) octanoate (BorchiKat 24) is added, and 14 g (67 mmol) isocyanatopropyltrimethoxysilane (% NCO=19.9) is then mixed in. After stirring for one hour at 80° C., the resulting polymer is cooled and has 7.1 g vinyltrimethoxysilane and 5.3 g of a mixture of 70 wt % bis(1,2,2,6,6,-pentamethyl-4-piperidyl) sebacate and 30 wt % methyl-1,2,2,6,6-pentamethyl-4-piperidyl sebacate (Tinuvin 765) added to it. The product is stored in moisture-tight fashion under a nitrogen atmosphere in a glass vessel before being further processed into a curable composition in accordance with the general protocol.

### Silane-Modified Prepolymer 2

326 g (28 mmol) polypropylene glycol 12000 (OH number=9.7) is dried in a 500 ml three-neck flask at 80° C. under vacuum. Under a nitrogen atmosphere at 80° C., 0.07 g bismuth(III) octanoate (BorchiKat 24) is added, and 11.4 g (68 mmol) isocyanatomethyldimethoxysilane (% NCO=24.9) is then mixed in. After stirring for one hour at 80° C., the resulting polymer is cooled and has 7.0 g vinyltrimethoxysilane and 5.3 g of a mixture of 70 wt % bis(1,2,2,6,6,-pentamethyl-4-piperidyl) sebacate and 30 wt % methyl-1,2,2,6,6-pentamethyl-4-piperidyl sebacate (Tinuvin 765) added to it. The product is stored in moisture-tight fashion under a nitrogen atmosphere in a glass vessel before being further processed into a curable composition in accordance with the general protocol.

Examples (quantities indicated in %):

| | Example 1 | Ex. 2 | Ex. 3 | Ex. 4 | Ex. 5 |
|---|---|---|---|---|---|
| Silane-modified | 41.5 | 55.0 | 55.0 | 83.0 | 73.0 |
| prepolymer 1 | | | | | |
| Prepolymer 2 | 41.5 | 28.0 | 28.0 | | |
| Mesamoll | | | | | 10.0 |
| Catalyst | | | 0.03 | 0.03 | 0.03 |
| (Sn-based) | | | | | |
| Aerosil 0X50 | 10.0 | 10.0 | 10.0 | 10.0 | 10.0 |
| Aminosilane 1 | 5.0 | 5.0 | | 5.0 | |
| Aminosilane 2 | | | | | 5.0 |
| Triethoxy- | 2.0 | 2.0 | 2.0 | 2.0 | 2.0 |
| vinylsilane | | | | | |
| Viscosity, | 32,000 | 45,000 | 42,000 | 7000 | 5000 |
| mPas (25° C.) | | | | | |

Aminosilane 1: Aminoethyl-3-aminopropyltrimethoxysilane
Aminosilane 2: N-(2-aminoethyl)-3-aminopropyltrimethoxysilane
Aerosil 0X50: SiO₂, 50 m²/g surface area

The constituents are mixed and degassed. The adhesive is then shelf-stable in the absence of moisture.

Comparative experiment 1: UR6082 is a two-component polyurethane adhesive of the Henkel company.

Comparative experiment 2: Example 1, without filler.

A variety of film substrates were adhesively bonded using the adhesives. The substrates were cured at room temperature, and breaking strength was determined at daily intervals.

| | | | | | | Corona | Corona | Temp. in | | |
|---|---|---|---|---|---|---|---|---|---|---|
| | | | | | Appl. | pretreatment | pretreatment | application | CA | CA after |
| | | | | Secondary | weight | on carrier | on secondary | mechanism | (1 d, 2 d, 3 d, 7 d, | boiling |
| Base | Hardener | MR | Carrier web | web | (g/m²) | web | web | (° C.) | 10 d, 14 d) | (7 d, 14 d) |
| Comp. 1 | UR6082 | 100: | OPP | OPP | 2.0 | ✓ | ✓ | 45 | ✓ | ✓ |
| | | 40 | | | | | | | | |
| Comp. 1 | UR6082 | 100: | PET/AI precomposite | PE | 2.0 | x | ✓ | 45 | ✓ | ✓ |
| | | 40 | | | | | | | | |
| Ex. 1 | — | — | OPP | OPP | 2.0 | ✓ | ✓ | 33 | ✓ | ✓ |
| Ex. 1 | — | — | PET/AI precomposite | PE | 2.0 | x | ✓ | 33 | ✓ | ✓ |
| Ex. 2 | — | — | OPP | OPP | 2.0 | ✓ | ✓ | 40 | ✓ | ✓ |
| Ex. 2 | — | — | PET/AI precomposite | PE | 2.0 | x | ✓ | 40 | ✓ | ✓ |
| Ex. 3 | — | — | OPP | OPP | 2.0 | ✓ | ✓ | 33 | ✓ | ✓ |
| Ex. 3 | — | — | PET/AI precomposite | PE | 2.0 | x | ✓ | 33 | ✓ | ✓ |
| Ex. 4 | — | — | PET/AI precomposite | PE | 2.0 | x | ✓ | 33 | ✓ | ✓ |
| Ex. 5 | — | — | PET/AI precomposite | PE | 2.0 | ✓ | x | 33 | ✓ | ✓ |
| Comp. 2 | — | — | OPP | OPP | 2.0 | ✓ | ✓ | 33 | | ✓ |
| Comp. 2 | — | — | PET/AI precomposite | PE | 2.0 | x | ✓ | 33 | | ✓ |

| Basis | Plies | CA after 1 d | CA after 2 d | CA after 3 d |
|---|---|---|---|---|
| Comp. 1 | OPP-OPP | 0.54 CS, both sides, tacky | 2.85, coex tear | 3.07, coex tear |
| Comp. 1 | PET/AI | 1.57 CS, AaS on PE, slightly | 3.44 CS, AaS on | 5.72 CS, AaS on |
| | (precomp.)-PE | tacky | PE, slightly tacky | PE |
| Ex. 1 | OPP-OPP | 2.83, coex tear | 1.96, coex tear | 2.23, coex tear |
| Ex. 1 | PET/AI | 2.36 CS, AaS on PE, tacky | 1.50 CS, PE, | 1.17 CS, AaS on |
| | (precomp.)-PE | | slightly tacky | PE |
| Ex. 2 | OPP-OPP | 0.99 CS, both sides, tacky | 3.29, coex tear | 2.75, coex tear |
| Ex. 2 | PET/AI | 1.83 CS, AaS on PE, slightly | 1.52 CS, AaS on | 1.15 CS, AaS on |
| | (precomp.)-PE | tacky | PE, slightly tacky | PE |
| Ex. 3 | OPP-OPP | 3.54, coex tear | 2.99, coex tear | 2.05, coex tear |
| Ex. 3 | PET/AI | 1.98 CS, AaS on PE, slightly | 1.23 CS, AaS on | 0.97 CS, AaS on |
| | (precomp.)-PE | tacky | PE, slightly tacky | PE |
| Ex. 4 | PET/AI | 0.93 CS, both sides, slightly | 2.23 CS, AaS on AI | 2.16 CS, AaS on |
| | (precomp.)-PE | tacky | | PE |
| Ex. 5 | PET/AI | 0.89 CS, AaS on PE, tacky | 2.08 CS, AaS on AI | 2.5 CS, AaS on PE |
| | (precomp.)-PE | | | |
| Comp. 2 | PET/AI | 0.6 CS, tacky | 1.5 CS, AaS on AI | |
| | (precomp.)-PE | | | |
| Comp. 2 | OPP-OPP | 0.25 CS, tacky | 1.5 CS, AaS on PE | |

CA: Composite adhesion: measured values N/15 mm, 90° pull test
AaS: Adhesive after separation
CS: Composite separation

Adhesive bonding with the OPP/OPP and PE/OPP substrates is good.

The comparative experiments exhibit poorer adhesive bonding behavior after 1 day.

What is claimed is:

1. A one-component moisture-curing laminating adhesive containing
a) at least one polyoxyalkylene and/or poly(meth)acrylate prepolymer having at least one hydrolyzable silane group,
b) 1 to 30 wt % fillers and/or pigments
c) auxiliary substances and additives,
wherein the prepolymer has a molecular weight of 4000 to 40,000 g/mol and the adhesive has a viscosity of 2000 to 100,000 mPas.

2. The one-component adhesive according to claim 1, wherein the adhesive comprises silane groups of formula (I)
—SiR³_{b}(OR)ₐ (I)
where R=C(O)R¹ or R², and R₁ and R₂=C₁ to C₁₀ alkyl,
R³=C₁ to C₆ alkyl and
a=1, 2, 3 and b=0, 1, 2,
preferably an average of 1.5 to 3 silane groups, in particular two terminal silane groups.

3. The one-component adhesive according to claim 1, wherein the prepolymer has a polydispersity (M_{W}/M_{N}) of D<3.

4. The one-component adhesive according to claim 1, wherein the adhesive contains 30 to 95 wt % of one or more polyoxyalkylene polymers and/or poly(meth)acrylate polymers having at least two silane groups; 0.1 to 10 wt % of at least one additional adhesion promoter; 1 to 30 wt % fillers; and 0.01 to 25 wt % auxiliary substances and additives; the sum of the constituents being equal to 100 wt %.

5. The one-component adhesive according to claim 1, wherein the adhesive is free of heavy metal catalysts.

6. The one-component adhesive according to claim 1, wherein the prepolymer is produced from polyether polyols or poly(meth)acrylate polyols by reacting the OH groups with an excess of diisocyanates, optionally removing the excess monomeric diisocyanates, and reacting the reaction product with compounds which contain a group that is reactive with NCO groups and a hydrolyzable silane group; or by reacting polyether polyols or poly(meth)acrylate polyols with isocyanatosilanes having a reactive silane group; or from polyethers or poly(meth)acrylates having unsaturated groups onto which, upon synthesis thereof by polymer-analogous reactions, reactive silane groups are terminally reacted, a reactive silane group of formula (I) being contained in each case.

7. The one-component adhesive according to claim 6, wherein aminosilanes or hydroxysilanes, or silanes having secondary amino groups, are used as a compound having reactive groups.

8. The one-component adhesive according to claim 6, wherein at least one of isocyanates having differently reactive NCO groups; aromatic isocyanates; and non-linear isocyanates, are used as a diisocyanate.

9. The one-component adhesive according to claim 6, wherein isocyanates having differently reactive NCO groups are used as a diisocyanate.

10. The one-component adhesive according to claim 6, wherein aromatic isocyanates are used as a diisocyanate.

11. The one-component adhesive according to claim 6, wherein non-linear isocyanates are used as a diisocyanate.

12. The one-component adhesive according to claim 1, wherein SiO₂ in finely divided form and having a surface area (BET) of less than 100 m²/g, is used as filler.

13. An adhesively bonded article comprising a cured reaction product of the adhesive of claim 1 adhesively bonded to a flexible substrate having a metal, paper, cardboard, plastic and/or coated or printed surface.

14. An adhesively bonded article comprising a cured reaction product of the adhesive of claim 1 adhesively bonding a multi-layer film.
